(19) United States
(12) Patent Application Publication
(10) Pub. No.: US 2015/0302723 A1
(43) Pub. Date: Oct. 22, 2015

(54) Battery Monitor and Controller

(71) Applicant: Ark Corporation Pty Ltd, Arndell Park (AU)

(72) Inventors: Andrew READE, Arndell Park (AU); Richard ARAKELIAN, Arndell Park (AU)

(21) Appl. No.: 14/688,368

(22) Filed: Apr. 16, 2015

(30) Foreign Application Priority Data
Apr. 16, 2014 (AU) 2014901400

(51) Int. Cl. G08B 21/18

(52) U.S. Cl. CPC G08B 21/18

(57) ABSTRACT

A system for monitoring a battery condition, the system including:
one or more sensors configured to sense one or more battery performance parameters;
a computer processor configured to monitor battery condition and associated with the one or more sensors;
a transmitter for communicating wirelessly with a remote electronic device having a display for displaying the battery performance parameters on the display.

### TECHNICAL FIELD

The present invention relates generally to systems for remote monitoring, testing and/or controlling battery charge and condition. The present invention also relates generally to methods, software applications and electronic devices for remotely monitoring and/or testing and/or controlling battery condition.

### BACKGROUND

Known battery monitoring and/or control devices must be hardwired to the battery which is being monitored. These arrangements require leads between the battery and the monitoring and/or control devices. For good signal to noise ratio in the leads, the monitor or control device should be very close to the battery. Also, the leads can be easily broken, or frayed by heat in an engine bay or decayed from other heat sources or vibration sources, or become a trip or other hazard, or are cumbersome to install and use.

The monitoring and charge devices known are limited in functionality to checking voltage, and are flawed in that they keep charging when they may not be required to do so, thus wasting energy. In other circumstances, perfectly good batteries are disposed of since the monitoring devices cannot accurately ascertain the condition of a battery.

The present inventors have developed a new device for remotely monitoring and/or controlling battery charge and condition.

### DISCLOSURE OF INVENTION

Broadly, an aspect of the present invention provides a method for remotely monitoring battery condition by measuring battery parameters associated with a battery and wirelessly transmitting the battery parameters to a remote electronic device.

Broadly, another aspect of the present invention provides a method for remotely initiating a charge cycle on a battery by wirelessly sending a charge command with a wireless transmitter to a battery monitoring and control system electrically associated with the battery.

Broadly, a further aspect of the present invention provides a method of remotely assessing a battery condition, by measuring data associated with one or more battery parameters during a battery work task, assigning a battery rating to the data and wirelessly transmitting the data to a remote display.

Broadly, another aspect of the present invention provides a system for remotely assessing a battery condition, including sensors and meters for measuring a battery parameter during a battery work task, and a computer processing system for processing the data taken by the meter and applying a rating to the data.

Broadly, a still further aspect of the present invention provides a system for remotely initiating a charge cycle on a battery, including a wireless transmitter and a monitoring system electrically associated with the battery.

Broadly, a yet further aspect of the present invention provides a smartphone application for remotely monitoring a battery condition and/or controlling charging and discharging a battery.

Broadly, yet another aspect of the present invention provides a smartphone application for remotely controlling powering of battery-powered machinery.

In one aspect, the present invention provides a system for monitoring a battery condition, the system including:
one or more sensors configured to sense one or more battery performance parameters;
a computer processor configured to monitor battery condition and associated with the one or more sensors;
a transmitter for communicating wirelessly with a remote electronic device having a display for displaying the battery performance parameters on the display.

In another aspect, the present invention provides a computer-implemented method for monitoring a battery condition from a position remote from the monitored battery, the method including the steps of:
sensing, with one or more sensors, data relating to one or more battery performance parameters;
wirelessly transmitting the battery performance parameter data to a remote electronic device having a display;
displaying the battery parameter data on the display.

In one embodiment there is provided a computer processing system configured to receive battery performance parameter data from the sensors before wireless transmission. There may be one or more computer processing systems configured to receive battery performance parameter data from the sensors; one may be proximal the battery, one may be remote from the battery. Each one of the processing systems may conduct a portion of the battery parameter data processing, one may simply relay the data, one may simply receive and display.

In one embodiment there is provided an input apparatus for receiving input from a user and an output device for displaying battery condition output from the processor.

In one embodiment there is provided a plurality of electrical sensor inputs for receiving electrical sensors, the plurality of electrical sensor inputs being connected to the computer processor. In one embodiment there is provided an array of individual and wireless-enabled sensors adjacent the battery for receiving data therefrom, each one transmitting their data directly to a remote device for further processing and display.

In another aspect of the present invention, there is provided a computer-readable storage medium containing instructions to implement a method of remote monitoring a battery on a computer processing device, the method including the steps of:
sensing, with one or more sensors associated therewith, data relating to one or more battery performance parameters;
wirelessly transmitting battery performance data to a remote electronic device having a display;
displaying the battery parameter data on the display.

In one embodiment the method may include the step of receiving into a computer processing system, battery performance parameter data from the sensors.

In yet another aspect, the present invention provides a method of testing a battery condition, the method including the steps of:
measuring with one or more battery parameter sensors, during a battery work task, one or more battery parameters;
calculating, with a computer processor, the lowest of each one of the measured one or more battery parameters during the battery work task;
comparing with a computer processor the lowest of each one of the measured one or more battery parameters against a relevant threshold;
assigning with a computer processor a rating to the battery based on the lowest value of the battery parameter;
displaying the rating on a display.

In one embodiment the method includes the step of transmitting wirelessly to a remote electronic device having a display, the one or more battery parameters and/or the battery rating. In another embodiment the method may include the step of wirelessly transmitting the battery parameters to the remote electronic device for calculating in that device.

In still another aspect the present invention provides a system for testing a battery condition, the system comprising:
one or more battery parameter sensors configured for electrical communication with the battery;
a computer processor configured to calculate the lowest value of each one of the measured one or more battery parameters;
a memory configured to store battery parameters, threshold battery parameter values and battery condition ratings;
a display for displaying the battery parameter and/or the rating.

In one embodiment a housing is provided for housing the system as a standalone system, without housing the battery, but directed to inhibiting damage to the battery testing and control system from environmental factors such as heat, water spray, bumps and the like. In one embodiment one display is mounted on the housing.

In one embodiment the display one the housing and the display on the remote electronic device is a display screen, which may be a powered panel for displaying messages and pictures, being an LED, LCD and the like.

In one embodiment there is provided a transmitter configured to transmit the battery parameters and battery condition rating data and other associated testing data to a secondary display, being remote from the housing.

In one embodiment the display is a smartphone which is configured to wirelessly receive the battery rating data and other battery parameter data from the computer processor associated with the battery.

In one embodiment the sensors include voltage sensors but may include current sensors. In one embodiment the sensors include voltage meters, current meters and like battery parameter meters.

In one embodiment the system includes a vessel or box to house the battery. In one embodiment the system is housed in the vessel or box. In one embodiment the vessel or box includes a main portion, open a top, to receive a battery. In one embodiment, the battery is 6V, 12V, 24V, 48V or like potential. The battery can be a starting battery or a deep cycle battery. The battery composition may also be variable, including AGM/Lead Acid, Gel, Calcium, Lithium Oxide or Lithium Ferro Phosphate.

In one embodiment the box includes a lid to receive the processor, input/output apparatus and transceiver. In one embodiment the vessel includes handles disposed in a side of the box so that lifting forces are directed into the side wall and not the lid, so the lid is inhibited from opening while under the battery lifting load.

In one embodiment the method includes the step of requesting a battery type on the remote electronic device so that a more accurate calculation of battery charge remaining may be made. To be clear, any calculation of any one of the parameters, or performance characteristics for example battery charge remaining may be made either by the remote electronic device or by the computer processing system associated with the local battery monitor and control system adjacent the battery.

In one embodiment the method includes the step of selecting a charging profile depending on the input into the processing system of data relating to a type of battery to be charged.

In one embodiment the method includes the step of amending a calculation of battery capacity and battery charge time remaining and battery discharge time remaining depending on the input into the processing system of data relating to a type and/or capacity of battery to be charged or controlled.

In one embodiment the method includes the step of requesting input from a user of a battery capacity on the remote display to facilitate calculation of a battery capacity remaining.

In one embodiment the method includes the step of displaying a request for parameter data relating to a type of charging power source for facilitating selection of a charge profile.

In one embodiment the method includes the step of selecting a charging profile depending the input into the processing system of data relating to a type of charging power source.

In one embodiment the method includes the step of transmitting charge initiating or discharge initiating commands to selected ports on the battery.

In one embodiment the electrical sensor inputs are ports or sockets or connectors or posts or other fasteners for receiving and removably fastening electrical wires from the battery. In another embodiment the electrical sensor inputs are wireless units which transmit their data to the battery monitoring computer processing unit.

It is contemplated that the sensors may be wireless units which send their data directly to the remote electronic device for further processing.

In one embodiment the sensors are configured to sense electrical potential or voltage. In one embodiment the sensors are configured to sense current. In one embodiment the sensors are configured to sense temperature.

In one embodiment the computer processor includes a clock so that a timer is provided. In one embodiment the clock is configured to time selected operations so that the computer processor can selectively time the switching on and switching off of selected electrical inputs and/or outputs.

In one embodiment the battery parameter and/or battery rating output is displayed on a Light Emitting Diode (LED)—either single diode lights or a powered display panel—liquid crystal display (LCD) screen or panel or the like. In one embodiment the LED or LCD screen or panel is backlit. In one embodiment the LED or LCD screen has touch functionality. In one embodiment the LED or LCD is about 75 mm square. It will be appreciated that the LED or LCD may be any appropriate size.

In one embodiment the transceiver transmits using a short wavelength, being a frequency range of about 2.4 to 2.485 GHz. In one embodiment the transceiver operates using the Bluetooth protocol. In another embodiment the transceiver operates using a Wi-Fi (IEEE 802.11) wireless protocol.

In one embodiment the input device is a keyboard or keypad. In one embodiment the keyboard or keypad includes a plurality of input keys for selecting menu items from a menu on the display. In one embodiment there are four keys but any number of keys may be suitable. In one embodiment the input device is a keyboard or other device temporarily displayed on the screen. In one embodiment the input device and output device are the same element, being a touch-sensitive screen.

In one embodiment the processor is a smartphone, a PLC, PCB, one or more Raspberry Pi, Arduino, or indeed any other suitable computer.

In another aspect, the present invention provides a remote device for monitoring a battery charge, the remote device including:
a transmitter-receiver or transceiver for receiving and transmitting data wirelessly with a system for monitoring a battery charge;
a processor for processing the data from the system for monitoring battery charge; and
an input/output apparatus for receiving input from a user and displaying output from the processor.

In one embodiment the output apparatus includes an LED or LCD screen. In one embodiment the LED or LCD screen is about 75 mm square. It will be appreciated that the LED or LCD screen may be any appropriate size. In one embodiment the LED or LCD screen is backlit. In one embodiment the LED or LCD screen has touch functionality. The LEDs may be integrated into the body of the housing and being behind a translucent wall so that the screen seamlessly integrates with the wall.

In one embodiment the transmitter-receiver or transceiver transmits using a short wavelength signal, being a frequency range of about 2.4 to 2.485 GHz. In one embodiment the transceiver operates using the Bluetooth protocol. In another embodiment the transceiver operates using a Wi-Fi (IEEE 802.11) wireless protocol.

In one embodiment the processor is a smartphone, a PLC, PCB, one or more Raspberry Pi, Arduino, or indeed any other computer.

In yet another broad aspect there is provided a method of remotely monitoring a battery charge with a computer processor, the method including the steps of:
wirelessly receiving data into the computer processor from a system for monitoring battery charge; and
displaying the data on a screen associated with the computer processor.

In one embodiment the method includes the step of initiating a charge cycle in the battery by wirelessly transmitting a charge command to the system for monitoring battery charge.

In one embodiment the method includes the step of terminating a charge cycle by transmitting a command to terminate a charge cycle to the system for monitoring battery charge.

According to another aspect of the present invention there is provided a remote computer processing device for control of a battery, the remote computer processing device including:
a wireless receiver for wirelessly receiving data from a system for monitoring battery charge and/or controlling the operation of the battery;
a display screen for displaying the wirelessly received data;
an input device for receiving commands from a user of the computer processing device;
a wireless transmitter for wirelessly sending control commands to the system for monitoring the battery charge and/or controlling operation of the battery to control charge or discharge of the battery.

In one embodiment the remote computer processing system includes an input device for receiving user commands for controlling a battery by transmitting control commands to the system for monitoring battery charge or controlling the operation of the battery.

In one embodiment the processing system for monitoring battery charge or controlling operation of the battery includes a receiver for receiving the wireless signal from the remote computer processing device.

In one embodiment the processing system includes relays for relaying an electrical command signal from the receiver to other areas for implementing the received control commands.

In one embodiment the processing system for monitoring the battery charge or controlling operation of the battery includes one or more maximum power point tracking (MPPT) modules to extract maximum charge from photovoltaic panels when connected to the processing system.

In one aspect, the present invention provides a system for monitoring a battery charge, the system including:
a processor for monitoring battery condition;
a plurality of electrical sensor inputs for receiving electrical sensors, the plurality of electrical sensor inputs being connected to the processor;
a meter for measuring electrical potential between the electrical sensor inputs;
an input/output apparatus for receiving input from a user and displaying output from the processor; and
a transceiver for communicating wirelessly with a remote electronic device for displaying battery condition at a remote location.

In another aspect, the present invention provides a remote device for monitoring a battery charge, the remote device including:
a transmitter-receiver or transceiver for receiving and transmitting data wirelessly with a system for monitoring a battery charge;
a processor for processing the data from the system for monitoring battery charge; and
an input/output apparatus for receiving input from a user and displaying output from the processor.

Throughout this specification and the claims that follow, it is to be understood that transmitter-receiver and transceiver are interchangeable terms. That is, whether the transmitter and receiver share components is irrelevant to the operation of any embodiments of the invention.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this specification.

In order that the present invention may be more clearly understood, preferred embodiments will be described with reference to the following Figures.

### BRIEF DESCRIPTION OF THE FIGURES

FIG. 1 is a schematic drawing of a processing system which is a component of an example embodiment of the present invention;

FIG. 2 is a schematic diagram of components of the processing system which is a component of an embodiment of the present invention;

FIG. 3 is a schematic drawing of an example embodiment of the present invention.

FIG. 4 is a schematic of an embodiment of the present invention;

FIG. 5 is a detail of a screen on a monitoring and/or charging system of an embodiment of the present invention;

FIG. 6 is a display output which can be shown on a remote screen of a remote monitoring device in accordance with a component and an embodiment of the present invention;

FIG. 7 is a display output of one page of a smartphone app showing the outcome of a battery diagnostic test;

FIG. 8 is a page of a smartphone app showing a request for input data relating to battery type and input power source;

FIG. 9 is a plan view of a component of a system for monitoring and controlling a battery, the component being a computer processing system for receiving sensors and sensor data and transmitting the sensor data to a smartphone;

FIG. 10 is an isometric view of the computer processing system of FIG. 9;

FIG. 11 is a side elevation view of the computer processing system of FIG. 9;

FIG. 12 is an end elevation view of the computer processing system of FIG. 9;

FIG. 13 is a schematic view of a control system for control and monitoring of a battery which can be used with a wireless transmitter as described herein and relay devices to remotely control and monitor a battery housed in a housing and having a local display; and

FIG. 14 is a battery charger and portable power supply having a housing, the schematic for which is shown in FIG. 13.

### DETAILED DESCRIPTION OF EMBODIMENTS OF THE INVENTION

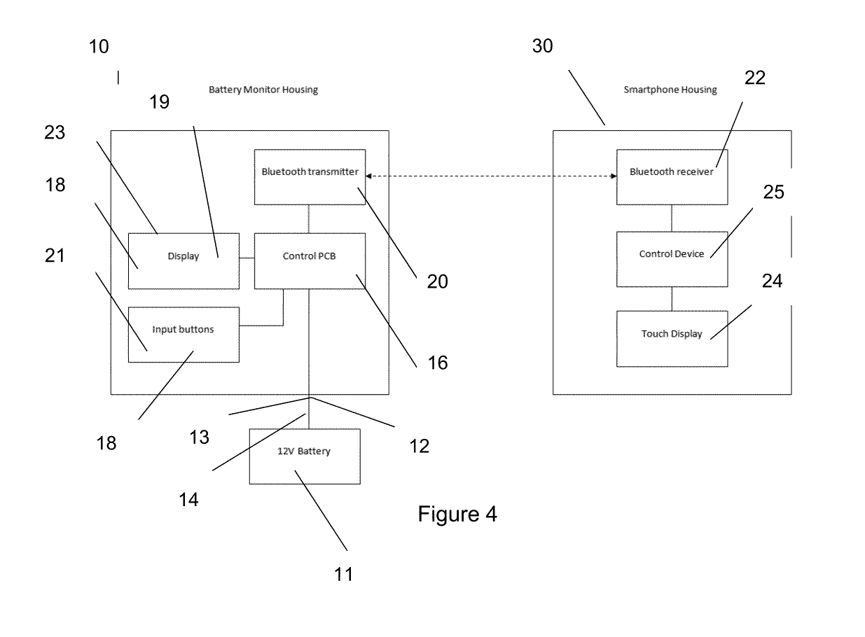

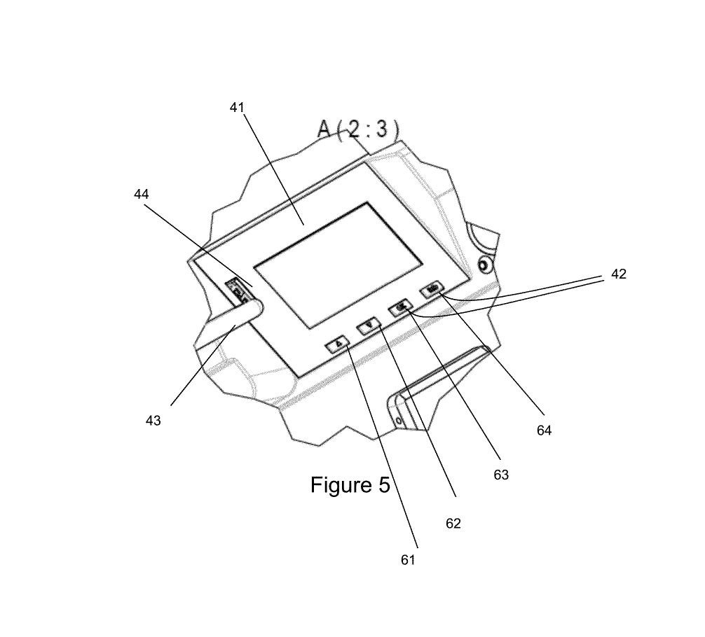

Referring to FIG. 4 there is shown in schematic form a system for monitoring a battery charge generally indicated at 10. The system includes a processor 16 for monitoring battery condition; a plurality of electrical wire or sensor inputs 12 for receiving electrical wires and/or sensors 14, each one of the plurality of electrical sensor inputs being connected to the processor 16; one or more sensors for taking battery parameter data, which in one embodiment is electrical potential data between the wires connected to a battery; an input/output apparatus 18 for receiving input from a user and displaying output from the processor 16; a transceiver 20 for communicating wirelessly with a remote electronic device 30 for displaying battery condition at a remote location.

As described herein, the arrangement may be such that one or more of the sensors may be individually (or as a couple) capable of wirelessly transmitting battery parameter data directly to the remote electronic device 30, or the sensors may be arranged to input to the central computing processor 16 for immediate wireless transmission to the electronic device 30 for further processing there, or the central computing processor 16 may perform calculations locally there before wirelessly transmitting the processed data to the electronic device 30.

The electrical sensor inputs 12 are ports or sockets 13 or connectors or posts or other fasteners for receiving and removably fastening electrical wires from the battery.

The sensor may be voltage sensors, temperature sensors, current sensors and other suitable sensing devices relevant to battery control and monitoring.

Output from the processor 16 is displayed on the input/output apparatus 18 which is in the form of an LED screen or LCD screen 19. The LED or LCD screen 19 is about 75 mm square.

The transceiver transmits using a short wavelength, being a frequency range of about 2.4 to 2.485 GHz. In one embodiment the transceiver operates using the Bluetooth protocol. In another embodiment the transceiver operates using a Wi-Fi (IEEE 802.11) wireless protocol.

The input device is a keyboard 21 but may be a touch screen. In the embodiment with the keyboard, it includes a plurality of input keys for selecting menu items from a menu on the LCD 19. In one embodiment there are four keys but any number of keys could be suitable and the input device could be a keyboard or other controller temporarily displayed on the LCD 19. Thus, in one embodiment the input device and output device 18 are the same element, being a touch-sensitive screen 23.

The system includes a socket for connecting a power supply to the battery monitoring system so that the battery may be charged from the power supply.

In one embodiment the processor is a smartphone, a PLC, PCB, one or more Raspberry Pi, Arduino or indeed any other computer.

The system 10 includes a charging algorithm such that the battery can be charged in accordance with the algorithm.

There is also shown in FIG. 4 a remote device 30 for monitoring a battery charge, the remote device 30 including: a transceiver 22 for receiving and transmitting data wirelessly from and to the system for monitoring and/or controlling a battery charge 10; a processor 25 for processing the data from the system for monitoring battery charge; an input/output apparatus 24 for receiving input from a user and displaying output from the processor.

The processor may also initiate a battery charge by transmitting an initiate charge signal to the system 10. Of course, this initiate charge signal will only charge the battery when the battery monitoring system 10 is connected to a general power outlet or similar.

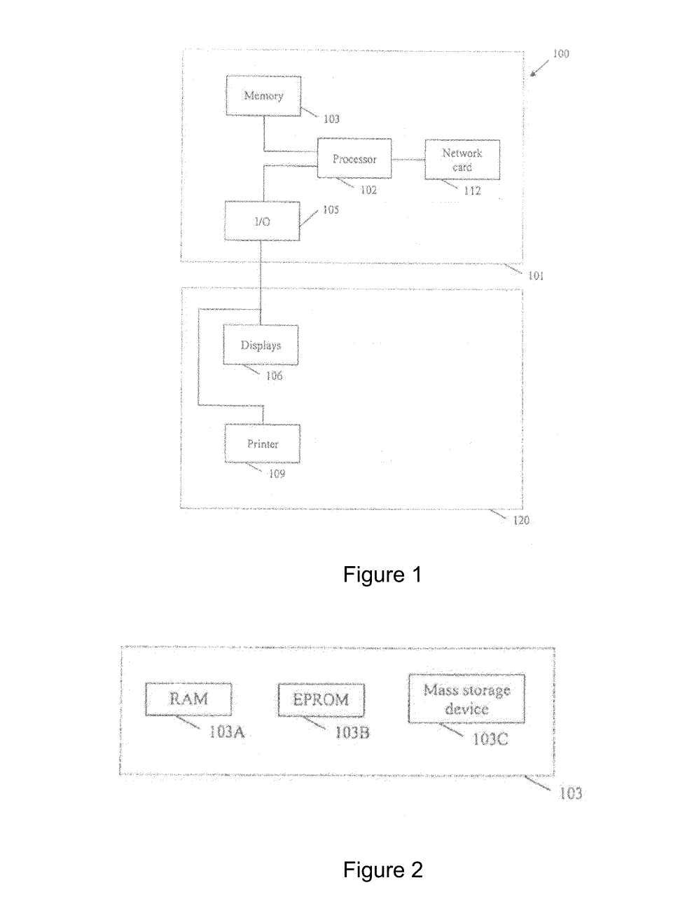

FIG. 1 shows a block diagram of operative components of a battery monitoring and/or charging system 100 which is one of the kinds of system which is the present invention, a component of the present invention, or to enact the method of a preferred embodiment of the present invention. The battery monitoring and/or charging system of preferred embodiments of the present invention may include or be part of a desktop computing system, a smartphone, a PCB system, one or more Raspberry Pi, Arduino, or indeed any other computer, with components generally as hereinafter described.

The battery monitoring and/or charging system 100 includes a processing machine 101 having a processor 102. Instructions and data to control operation of the processor 102 in accordance with the present invention are stored in a memory 103 which is in data communication with the processor 102.

Typically, the battery monitoring and/or charging system 100 will include both volatile and non-volatile memory and more than one of each type of memory, with such memories being collectively represented by the memory 103.

Among other things, the memory stores two reference voltage maps for each battery type—a first map, being a charging map, and a second map, being a discharging map. The processor is caused by the software to consult these maps from time to time so as to assess the condition of the battery and to display that battery condition during charging and/or discharging on the display 41. Example charge maps are shown in the table below and comprise an array of battery condition percentage values which correspond to selected voltage values. The charge maps for each battery type thus indicate to the processor the battery capacity level expressed as a percentage, when the processor has received a battery charge value.

| | |
|---|---|
| Charge Map | Discharge Map |

| | | | |
|---|---|---|---|
| 0% | 10.8 V | 0% | 10.8 V |
| 10% | 11 V | 10% | 11 V |
| 20% | 11.4 V | 20% | 11.2 V |
| 30% | 11.8 V | 30% | 11.4 V |
| 40% | 12.2 V | 40% | 11.6 V |
| 50% | 12.6 V | 50% | 11.8 V |
| 60% | 13 V | 60% | 12 V |
| 70% | 13.2 V | 70% | 12.2 V |
| 80% | 13.4 V | 80% | 12.4 V |
| 90% | 13.6 V | 90% | 12.6 V |
| 100% | 13.8 V | 100% | 12.8 V |

The processor 16 is then caused to display the percentage capacity of the battery and/or transmit it to the remote device 30. The processor 16 also is caused to calculate the time expected until the battery is fully charged or discharged, from the capacity information and from other data it is able to receive, such as the current draw or current input, (or a net current draw or net current input, if current is being both drawn and input). The algorithm for the calculations is described hereinafter.

Preferably a PCB will be used to process the above information and charge and condition the battery 11.

User input buttons or keys 42 include: Up Button 61; Down Button 62; “OK” Button 63; Information button 64.

### Example 1

In operation the processing system controls the charging and conditioning of the battery and monitors and displays the charge information for users in accordance with the description herein and the drawings.

To charge, a plug from an external power supply is inserted into the external power supply socket (not shown) for charging. The external power supply expects 24V and 6 A DC when in use.

The processor begins in a ready state and waits for charge input from the external power supply socket or a user input key 42.

A sensor in the processing system detects the presence of a charging voltage at the external power socket. The processor may cause the display 18 or 25 (when transmitted to the remote device 30) to read a welcome message: “Welcome to ARK smart charging. Please select battery type and press OK” [or similar].

The processor 16 will cause the display 18 and/or 25 to request the input of a battery type, by showing the following message or one like it:
Standard flood-type Lead Acid Battery
Gel Battery
Calcium Battery
AGM Battery

The processor waits until the user has toggled through the above list of battery types using the up/down buttons 61/62 (or the touch screen 24) until the selected battery type is highlighted and then waits for the user to press OK to confirm the battery type. The battery type could also be 12V, 24V and the like.

The processor then requests that the battery size (in terms of Ah) is then input by the user by the keys 21, 42 or 24 or selected from a list which is caused to be displayed on the display 41 (or 24). This quantity may then be used in a calculation by the software to assess battery charge remaining as described herein.

For example, if Gel battery is selected, the processor will cause the display to read: “Gel Battery selected. Charging commenced” [or similar].

The processor then causes the charging apparatus to commence a selected specific charging program for that battery type by introducing a selected amount of charge from the external power supply socket (not shown) to the battery terminals in a selected manner in accordance with a selected charging cycle programmed into the processing system. The charging programs are described below.

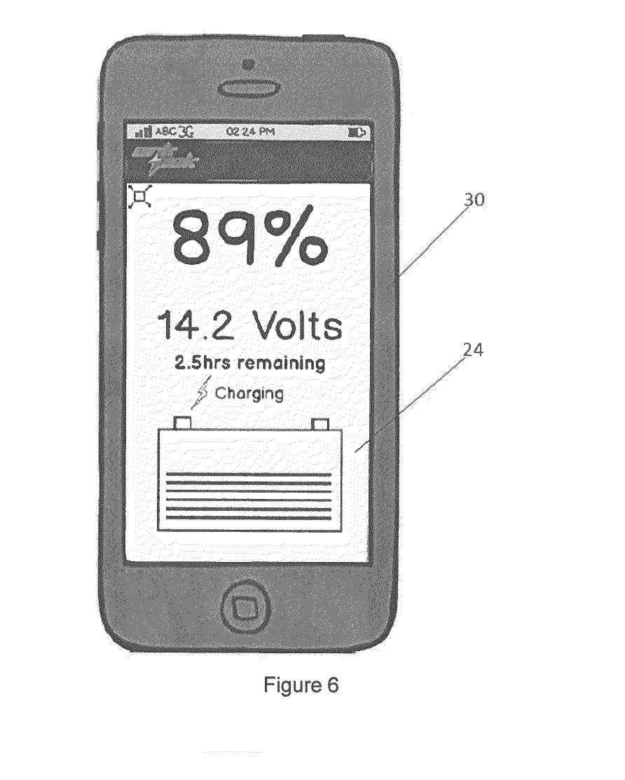

During charging the processor will cause the screen to display the message shown in FIG. 6. The processor causes the display 19 or 24 to update after a selected time period has elapsed, which in preferred embodiments is every 15 minutes.

The message caused to be displayed on the display 19 or 24 changes depending on the selected charging cycle which as discussed above depends on the type of battery selected.

### Example 2

It can be seen that there is provided a computer-readable storage medium 103 (and or FIG. 2) containing instructions to implement a method of remote monitoring a battery on a computer processing device, the method including the steps of: sensing, with one or more sensors 14 associated therewith, data relating to one or more battery performance parameters; wirelessly transmitting the battery performance parameter data to a remote electronic device 30 having a display 24; and displaying the battery parameter data on the display 24.

The method of the example includes the step of receiving into a computer processing system 16, battery performance parameter data from the sensors 14.

The example shown also provides a method of testing a battery condition, the method including the steps of: measuring with one or more battery parameter sensors 14, during a battery work task, one or more battery parameters; calculating, with a computer processor 16, the lowest of each one of the measured one or more battery parameters during the battery work task; comparing with a computer processor the lowest of each one of the measured one or more battery parameters against a relevant threshold; assigning with a computer processor 16 (or 30) a rating to the battery based on the lowest value of the battery parameter; displaying the rating on a display.

The method of the example includes the step of transmitting wirelessly to the remote electronic device 30 having a display 24, the one or more battery parameters and/or the battery rating. The method may include the step of wirelessly transmitting the battery parameters to the remote electronic device for calculation in that device.

In operation the user is prompted to start monitoring the battery for the purposes of diagnosing the battery condition. The monitor starts taking performance parameter data. A 30-second window of battery performance parameters is opened. Then the user (or the smartphone itself, if it is integrated into the starter motor cables) causes the battery to undergo a work task, such as for example actuating the starter motor. The system monitors the voltage of the battery during the starter motor actuation. The system records the lowest voltage during the 30-second window. The computer processor then assesses the lowest voltage against a threshold.

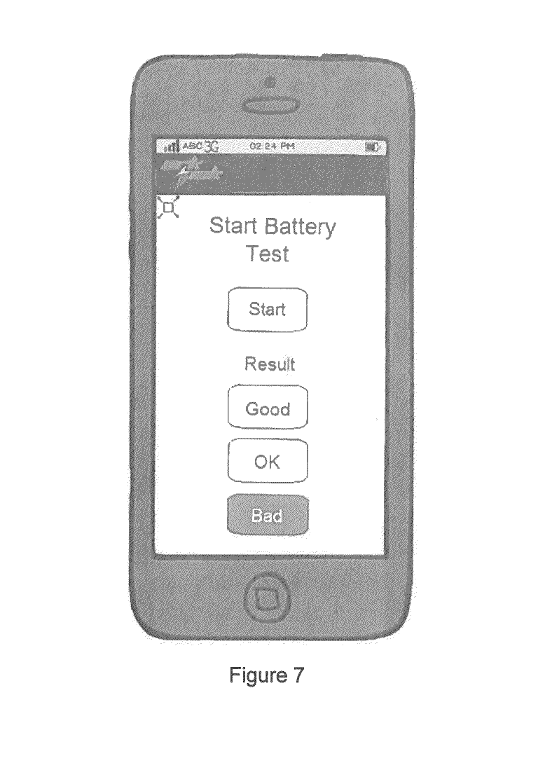

If the lowest voltage during the work task of starting the motor is lower than 9.8V the result is as shown in FIG. 7—BAD. The battery should be replaced. If the voltage during the test is between 9.8 and 10.8V then the battery is ok and can continue to be used but the user is warned that the battery may soon decay to the point where it is unusable. If the lowest voltage is greater than 10.8V during the work task then the user may have confidence that the battery is strong.

There is discussed herein a system for testing a battery condition, the system comprising: one or more battery parameter sensors configured for electrical communication with the battery; a computer processor configured to calculate the lowest value of each one of the measured one or more battery parameters; a memory configured to store battery parameters, threshold battery parameter values and battery condition ratings; a display for displaying the battery parameter and/or the rating.

A housing is provided for housing the system as a standalone system, without housing the battery, but directed to inhibiting damage to the battery testing and control system from environmental factors such as heat, water spray, bumps and the like. In one embodiment one display is mounted on the housing.

The display one the housing and the display on the remote electronic device is a display screen 24, which may be a powered panel for displaying messages and pictures, being an LED, LCD and the like.

There is provided a transmitter 20 configured to transmit the battery parameters and battery condition rating data and other associated testing data to a secondary display 24, being remote from the housing.

The display is on smartphone 30 which is configured to wirelessly receive the battery rating data and other battery parameter data from the computer processor associated with the battery.

The sensors 14 include voltage sensors but may include current sensors. In one embodiment the sensors include voltage meters, current meters and like battery parameter meters.

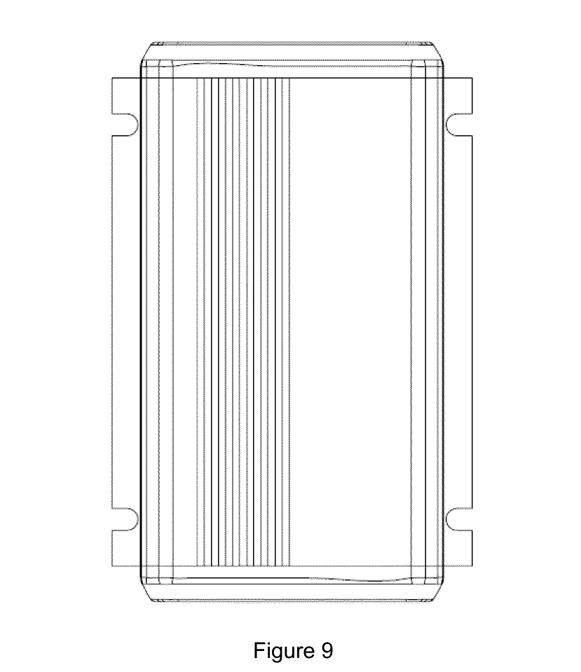

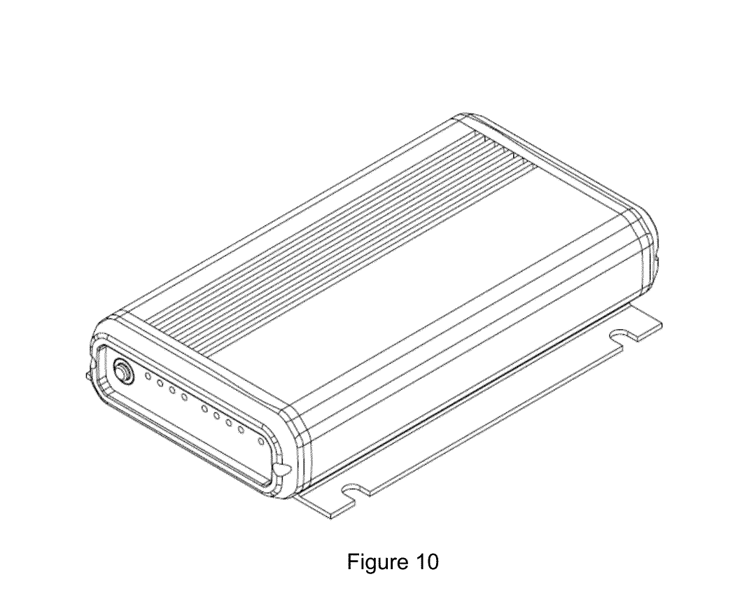

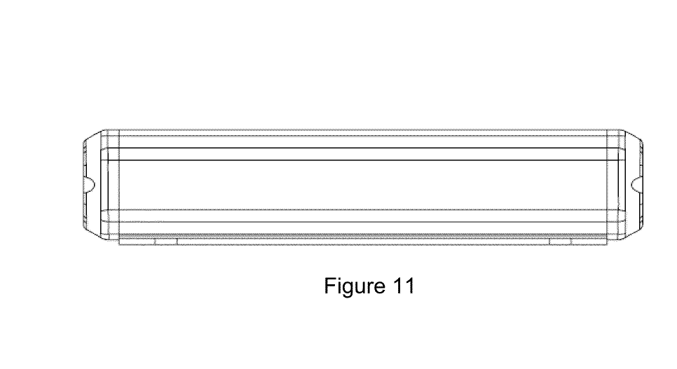

The system may include a box that is standalone to only house the local computer processing system 16 as shown in FIGS. 9 to 12

The system includes a vessel or box to house the battery as shown in FIG. 14. In one embodiment the system is housed in the vessel or box. The vessel or box includes a main portion, open a top, to receive a battery. In one embodiment, the battery is 6V, 12V, 24V, 48V or like potential. The battery can be a starting battery or a deep cycle battery. The battery composition may also be variable, including AGM/Lead Acid, Gel, Calcium, Lithium Oxide or Lithium Ferro Phosphate.

The box shown in FIG. 14 includes a lid to receive the processor, input/output apparatus and transceiver. In one embodiment the vessel includes handles disposed in a side of the box so that lifting forces are directed into the side wall and not the lid, so the lid is inhibited from opening while under the battery lifting load.

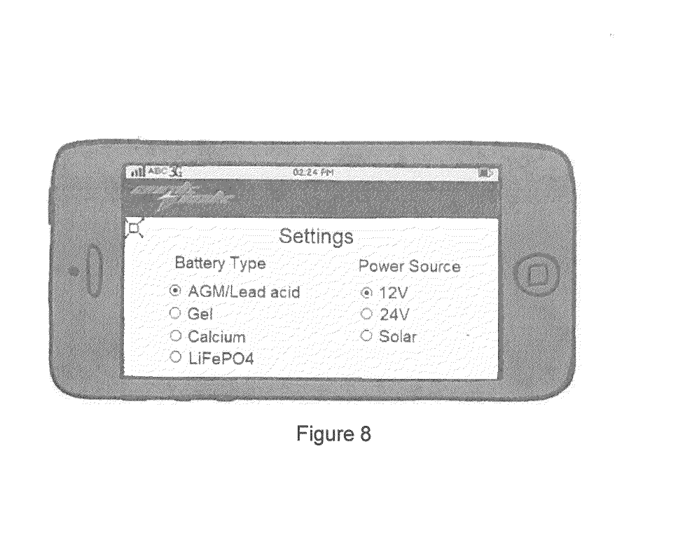

The method includes the step of requesting a battery type on the remote electronic device (FIG. 8) so that a more accurate calculation of battery charge remaining may be made. To be clear, any calculation of any one of the parameters, or performance characteristics for example battery charge remaining may be made either by the remote electronic device or by the computer processing system associated with the local battery monitor and control system adjacent the battery.

In one embodiment the method includes the step of selecting a charging profile depending on the input into the processing system of data relating to a type of battery to be charged.

In one embodiment the method includes the step of amending a calculation of battery capacity and battery charge time remaining and battery discharge time remaining depending on the input into the processing system of data relating to a type and/or capacity of battery to be charged or controlled.

The method in the example includes the step of requesting input from a user of a battery capacity on the remote display to facilitate calculation of a battery capacity remaining. (Shown in FIG. 8).

The method in the example includes the step of displaying a request for parameter data relating to a type of charging power source for facilitating selection of a charge profile. (FIG. 8).

The method in the example includes the step of selecting a charging profile depending the input into the processing system of data relating to a type of charging power source. (FIG. 8)

When the user inputs the data relating to a type of charging power source, the processor 16 provides varying charging power. Because driving a high power through cables at 12V would result in a higher current, the temperature can increase more than if there was the same power driven through at a higher voltage, say, 24V. Therefore the processor 16 drives the charge at a lower power and at, say, 50% or 75%, the power starts tailing off so that the temperature sensors do not cut out the charging operation. The sensors operate to cut out if the charger is too hot.

The MPPT is also provided to gain maximum power from the PV cells and they are actuated if the user requires them to be when he selects the Solar option in FIG. 8.

When a user is camping they can actuate lights which are connected to the GPO or other power outlets, by using a timer or by a separate screen which actively shuts down or provides power to those outlets from the smartphone 30. There may be WiFi or GSM or GPRS or other 3G or 4G functionality for remote operation of a distal pump connected to the battery.

The method in the example includes the step of transmitting charge initiating or discharge initiating commands to selected ports on the battery.

In one embodiment the electrical sensor inputs are ports or sockets or connectors or posts or other fasteners for receiving and removably fastening electrical wires from the battery. In another embodiment the electrical sensor inputs are wireless units which transmit their data to the battery monitoring computer processing unit.

It is contemplated that the sensors may be wireless units which send their data directly to the remote electronic device for further processing.

In one embodiment the sensors are configured to sense electrical potential or voltage. In one embodiment the sensors are configured to sense current. In one embodiment the sensors are configured to sense temperature.

In one embodiment the computer processor includes a clock so that a timer is provided. In one embodiment the clock is configured to time selected operations so that the computer processor can selectively time the switching on and switching off of selected electrical inputs and/or outputs.

In one embodiment the battery parameter and/or battery rating output is displayed on a Light Emitting Diode (LED)—either single diode lights or a powered display panel—liquid crystal display (LCD) screen or panel or the like. In one embodiment the LED or LCD screen or panel is backlit. In one embodiment the LED or LCD screen has touch functionality. In one embodiment the LED or LCD is about 75 mm square. It will be appreciated that the LED or LCD may be any appropriate size.

In one embodiment the transceiver transmits using a short wavelength, being a frequency range of about 2.4 to 2.485 GHz. In one embodiment the transceiver operates using the Bluetooth protocol. In another embodiment the transceiver operates using a Wi-Fi (IEEE 802.11) wireless protocol.

In one embodiment the input device is a keyboard or keypad. In one embodiment the keyboard or keypad includes a plurality of input keys for selecting menu items from a menu on the display. In one embodiment there are four keys but any number of keys may be suitable. In one embodiment the input device is a keyboard or other device temporarily displayed on the screen. In one embodiment the input device and output device are the same element, being a touch-sensitive screen.

### Charging

If a plug is inserted into the external power supply socket (not shown) the software will recognize that it should switch to charging mode, and will select one appropriate charging cycle, so as to function as set out below. The processor will measure and receive the battery voltage and then will be caused to select from a charge, conditioning or boost charging cycle accordingly, as is known to a person skilled in the art.

During charging the processing system causes the LCD 19 or 24 to display up to four qualities during charging—selected from, among other things, charging current (expressed in Amperes), discharge current (expressed in Amperes), cycle type, battery condition, voltage, and time remaining to full charge or full discharge.

For example, during a Charge Cycle, which is until the battery reaches 12.5V, the following qualities are caused to be displayed:

(a) Charge Cycle

(b) Battery condition expressed as a percentage of full (minor units in 1% increments)

(c) Battery Voltage expressed in units of Volts. (minor units in 0.1V increments) and

(d) Number of hours to full charge or discharge expressed in hours

The information button is the same as the on/off button—holding it down for an extended time will actuate the system, while touching the information button briefly will force a test.

Note: Hours are expressed in 0.5 hr increments

During Charge cycle, if battery does not reach 12.5 voltage after 25 hours the processor will cause the display to read a message such as for example “Alarm. Faulty battery.”

During a Boosting cycle wherein the processor maintains a constant voltage to the battery terminals for a period of 5 hours the processor causes the display 41 to display the following properties:

(a) Boosting Cycle

(b) Battery condition expressed as a percentage of fully charged

(c) Battery Voltage expressed in volts

(d) number of hours to go before fully charged

If battery fails to reach approximately 12.5V after 25 hours the processor will cause the display to read an alert message such as for example “Alarm. Faulty Battery” and then will cause the charger to commence a charging cycle known as a Conditioning cycle.

During a Conditioning cycle wherein the processor causes the battery to charge by maintaining constant voltage to the battery terminals at a current of approx 0.1 A the processor causes the display to display the following qualities:

(a) Conditioning (float) Cycle

(b) Battery condition expressed as a percentage of fully charged

(c) Battery Voltage expressed in Volts

Note: this cycle will maintain the constant battery voltage for 500 hours

### Testing

During charging, the processor is caused by the software, at selected time intervals, preferably 15 minutes, to stop charging the battery and rest the battery for a rest period. The rest period is for approximately 20 seconds. The processor, at the end of the 20-second rest period, is caused to detect the voltage across the terminals of the battery 11. The processor is then caused to compare that measured voltage value to a reference voltage stored in the charging map. The reference voltage corresponds with a figure on the charging map which is a percentage charge in the battery and the processor is caused to display that percentage charge on the display 41.

The processor is caused to select the charge map based on a net current flow value. That is, the processor is caused to measure the current flow in through the external power socket and the current flow out through the other ports or battery outlet, and makes a decision as to which charging map to consult, based on the net current flow.

The charging map and the discharging map are different to reflect that the battery capacities under charge differ under charge and discharge so this distinction is preferred to be made so the calculation is more accurate. For example, a battery with 90% charge might correspond to 12.6V under discharge conditions but a battery with 90% charge might correspond to 13.6V under charge conditions. Differing batteries have different charge maps.

The time until full charge is calculated using the quantities of:
a) battery capacity value from the reference map
b) the total battery capacity when full
c) current flow in
   in accordance with the equation below:

$$Timeremaining ( hrs ) = ( \frac{\% charge \times Ahcapacity}{Currentnow} )$$

That is:

Timeremaining=number of hours remaining until full discharge or charge

% charge=battery capacity remaining, taken from charge map

Ahcapacity=battery capacity when full, expressed in Ampere hours

Currentnow=net current to the battery ie charge current—strap current (flowing from the battery).

A similar equation is utilised for calculating time to discharge.

In between the 15-minute scheduled tests, the software receives current flow (Ampere) information at more frequent intervals from ammeters disposed to measure input current and output current and updates the display to display charge remaining percentage estimate figures.

### Discharging

Default mode for the charging processor system is discharge mode. When power is detected at the external power supply socket, the unit will commence charging, however, if there is a net outflow of charge, the display may show a time to discharge. That is, during net discharging the processor will recognize that the battery is in net discharging mode and will display a discharge message on the LCD 19 or transmitted to the remote screen 24.

When the information button is pressed during discharging i.e. an appliance is connected to the battery, the processor 16 will cause the LCD 19 or transmit to 24 to show:

(a) battery condition expressed as a percentage of fully charged

(b) Battery Voltage expressed in volts

(c) Number of hours at the present discharge rate remaining before the battery is fully discharged.

Unlike charging, the 15 minute rest stops are not caused to occur in net discharge mode. The processor is caused to constantly monitor (continuously, or every few seconds or milliseconds) the battery charge across the terminals while the battery 11 is discharging. The battery voltage measurement is compared with the discharge reference map.

A thermocouple is provided and connected to the processing apparatus. If the internal temperature of the box exceeds a selected temperature the processor will cause the display to read “warning-overtemperature” [or similar] and to sound a buzzer.

If the wires are connected to the wrong terminals the screen will read “wires connected to wrong battery terminals, reverse polarity to commence charging”. A buzzer sounds a warning.

The processing apparatus stores the selected battery type in its memory until battery is disconnected so that that information does not have to be input again by a user unless other circumstances dictate its input again.

### Charging and Discharging

A useful feature of preferred embodiments of the present invention is that the software and processor can calculate and cause the display to display the net charging rate or net discharging rate of the battery 11 if the battery is being charged and discharged simultaneously. That is, if, say, a light or a radio is being used, say, by being plugged into the GPO, and the battery is being charged at the same time, by use of the external power supply socket, then the net charging or discharging rate is calculated by the processor and then displayed on the LCD 19 or transmitted to 24. The software decides in this case to use an appropriate charge map depending on the net charge or discharge rate. Depending on the net charge or discharge rate, there may be a rest period as described hereinabove during which the battery voltage is measured so as to assist with capacity calculations.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

FIG. 2 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some battery monitoring and/or charging code. The mass storage device 103C is typically used to store battery monitoring and/or charging programs, the integrity of which may be verified and/or authenticated by the processor 102 using protected code from the EPROM 103B or elsewhere.

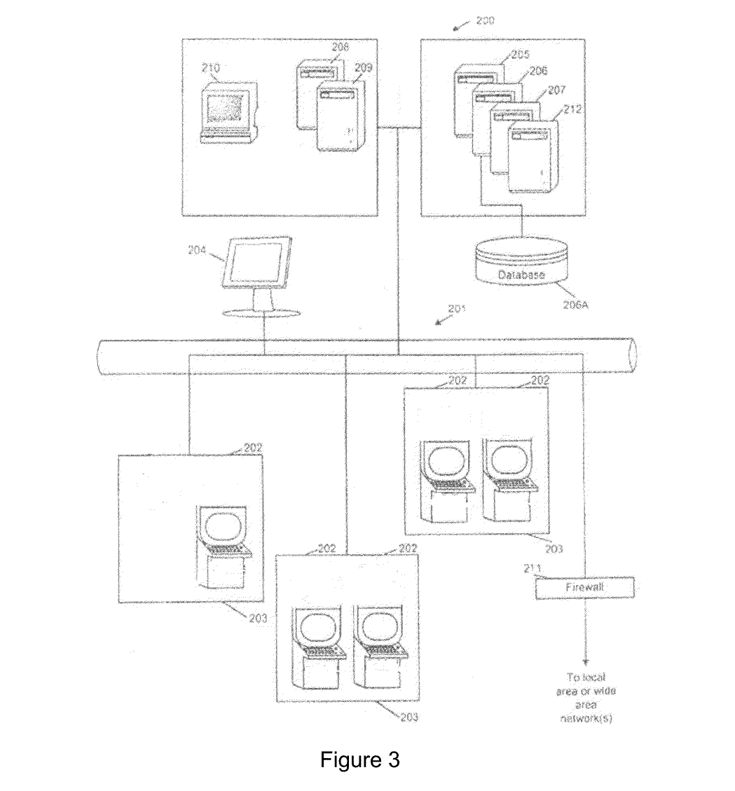

FIG. 3 shows a battery monitoring and/or charging system 200 in accordance with an alternative embodiment of the present invention. The battery monitoring and/or charging system 200 includes a network 201, which for example may be an Ethernet network, a LAN or a WAN. In this example, three banks 203 of computing terminals 202 are connected to the network 201. The computing terminals 202 each provide a user operable interface for connecting to battery charging sensor inputs and may be fully functional, or may have simplified functionality depending on the requirements for monitoring and/or charging remote batteries.

One or more secondary displays 204 may also be connected to the network 201. The displays 204 may, for example, be associated with one or more batteries 203. The displays 204 may be used to display battery condition information from 202.

In a thick client embodiment, a data processing server 205 implements one part of the battery monitoring and/or charging software and the computing terminal 202 implements another part of the battery monitoring and/or charging software. With this embodiment, as both the server 205 and the machine 202 implement part of the software algorithms, they collectively provide a data processor. A database management server 206 may manage storage of battery charging tables, programs and associated data for downloading or access by the devices 202 in a database 206A.

In a variation of the above thick client embodiment, the machine 202 may implement the algorithm, with the data processing server 205 functioning merely to serve data indicative of data input to the machine 202 for implementation.

With this latter implementation, a data signal containing a computer program usable by the client terminal to implement the processing system algorithms may be transferred from the server 205 to the client terminal 202, for example in response to a request by the client terminal.

In a thin client embodiment, the processing server 205 implements most or all of the software using a machine 202 and the machine 202 essentially provides only the interface. With this embodiment, the server 205 provides the controller. The machine 202 is a stripped down version of a computer and will receive processing instructions, and pass the instructions to the server which will process them and return battery condition outputs to the machine for display. In a thin client embodiment, the machines could be computer terminals, e.g. PCs running software that provides a player interface operable using standard computer input and output components.

Servers are also typically provided to assist in the administration of the system 200, including for example an administration server 208 and a security server 209 to monitor the access to various software and files. Another administrator terminal 210 is provided to allow an administrator to monitor the network 201 and the devices connected to the network.

The system 200 may communicate with other systems, other local networks such as a corporate network, and/or a wide area network such as the Internet, for example through a firewall 211.

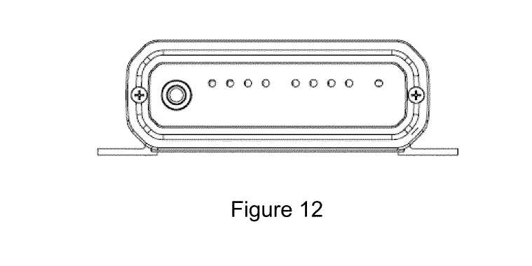

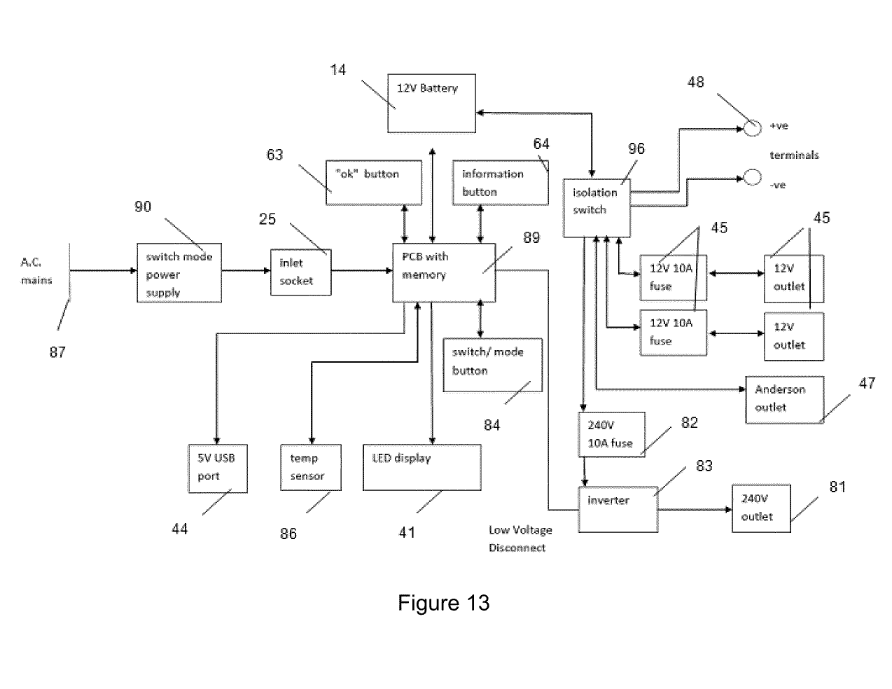

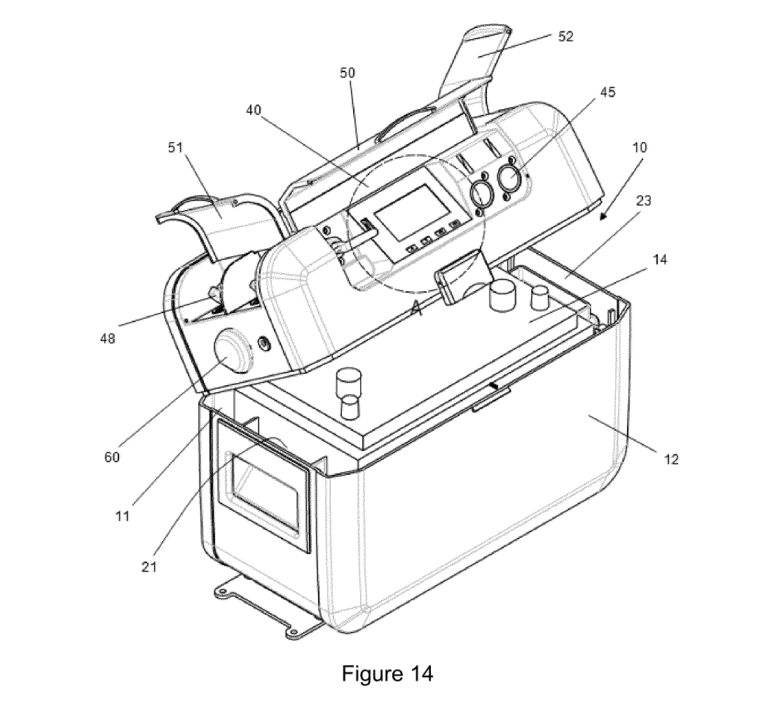

Referring to FIGS. 12 and 13 here is shown a portable battery box generally indicated at 10 and suitable for charging and housing a battery 14 when it is disposed within the battery box 10. The portable battery box 10 includes a main body 9 comprising a hollow base shell 12 which itself includes a base wall 16, opposed end walls 17 and 19, and opposed front and back walls 13 and 15, the opposed walls extending from the base wall 16 to a hollow base shell rim 11 which provides an opening 21 through which the battery can be placed so as to be disposed within a hollow chamber 23 for storage within the base shell 12.

The main body 9 includes a covering lid 20 which is in the form of a hollow lid shell 21 and includes a top wall 18 and a skirt depending therefrom, the skirt having opposed end walls 117, 119 and opposed front and back walls 113 and 115. The lid shell is operatively connected to open and close via a hinge on a back of rims 11 and 111. The opposed walls extend towards a lid rim 111 which, when the lid 20 is in a closed position, abuts the hollow base shell rim 11. The lid 20 is adapted to receive and mount control and monitoring electronic devices so as to facilitate their protection from water ingress. The lid shell also includes an interior panel 23 in order to provide structural support and to further cover battery charge and control electronics from water and other fluid ingress thereto.

The main body 9 also includes a fastener in the form of a clasp or latch 30 so as to fasten the hollow base shell rim 11 and the hollow lid rim 111 to one another when the shells are in a closed position. The clasp 30 is disposed along a front wall of the two rims at an intermediate position.

Electrical access ports 40 are provided and are operatively connected to the battery so as to control the charging or discharging of the battery and/or monitor selected parameters of the battery 14 or provide power to or from the battery. The electrical access ports 40 are mounted so as to be disposed adjacent one or more of the top, side, or end walls of the lid shell 21 and are recessed therefrom. In preferred embodiments at least an operational or control or user interface portion of the electrical access ports 40 is recessed from one of the walls. The electrical access ports 40 are mounted so as to be disposed within a recess set in from a wall.

The electrical access ports 40 include an LCD display 41, a plurality of user input keys or a mouse or trackball 42, an isolation switch 43, a plurality of USB slots 44, an external power supply socket 25, a DC cigarette lighter/alternative power source 45, a 240V or 110V AC General Power Outlet (GPO) 46, a 50 A Anderson plug 47 and a pair of DC battery posts (6, 12 or 24V) 48.

The DC battery posts 48 are disposed at a left-hand end of the lid shell 21 to facilitate ease of connection and access.

The LCD Display 41, user input keys 42, cigarette lighter sockets 45 and USB slots 44 are arranged along a front, top wall of the lid shell 21 for ease of user operation.

The hollow lid shell includes access covers 50, 51, 52 in order to cover the electrical access ports 40. The access covers 50, 51, 52 extend from the top wall to an adjacent side or end wall so that each forms a gullwing- or similar other curved shape and are movable from a closed position (shown in at least FIG. 1) to an open position (shown in at least FIG. 4). When the access cover 50 is in the closed position the electrical access ports 40 are substantially sealed and substantially protected from damage and inadvertent operation, for example, when packed in tightly in a boot or trunk of a vehicle with other items. The seal may be disposed on the cover or on the wall which the cover abuts when in the closed position.

When the access cover 50, 51, 52 is in the open position the electrical access ports 40 may be accessed and actuated.

The access covers 50, 51, 52 include hinges 53 and extend from the top wall 18 to a depending wall (113, 115, 117, or 119). The hinges 53 are disposed at the top wall end. A detent is provided to hold the access cover 50, 51, 52 in the open position and the hinges naturally tend to return the access covers to a closed position under the influence of gravity once a user releases them from the detent hold.

The access covers 50, 51, 52 may include a window or may be wholly translucent or transparent for ease of viewing the electrical access ports 40.

The hollow base shell 12 includes handles 70 which are disposed in the walls 17 and 19 of the base shell 12 so that when lifting the battery box 10, the lifting forces are taken substantially in a plane which is substantially parallel to the walls of the hollow base shell and not through the lid shell 21 and clasp 30. The handles 70 are integrated with the wall, in that they are recessed so that at least a face wall portion of the handle 70 is substantially flush with the wall 17 or 19.

The handles 70 include apertures 71 to facilitate cooling air from outside the battery box 12 into the chamber 23 for cooling the battery 14 and the electrical access ports 40. The handles include a surface which cooperates with a finger such that a ramp is provided to guide a finger into a radiused head portion disposed at an upper end of the ramp, the arrangement including a slight overhang. The apertures 71 are is disposed in an upper portion of the radiused overhang so that water may be inhibited from ingress to the chamber 23 through the apertures.

A cooling fan 60 is provided to cool the battery 14 and/or its electrical access ports 40. The cooling fan 60 is mounted in the lid left-hand wall 117. The fan 60 in operation, draws air in from the outside through the handle apertures and out through the lid or the other way around, depending on conditions.

The hollow lid shell 21 and hollow base shell 12 are adapted to be stackable within other lid shells and base shells to reduce volume during transport. The walls of the shells may flare or taper outwards to facilitate stacking.

Further control devices provided include an inverter and a battery charging unit (not shown). The battery charging unit may be powered from a 110v or 240v AC power source, a 12v or 24V DC power source or another suitable power source. The inverter may be removably mounted in the battery box. These devices and the other control devices generally are mounted in the lid portion 20 so as to inhibit water ingress to their componentry and to facilitate access thereto by users.

The battery 14 is removably held in place when disposed in the chamber 23 by a hook and loop strap fastener arrangement which when deployed extends across an upper face of the battery 14.

Schematic connections are shown in FIG. 13 and which show how the PCB connects with other elements of the battery box. That is, The AC mains are shown at 87 which connect to a switch mode power supply 90 and the external power supply socket 25. The socket 25 is connected to a processor in the form of a PCB 89. The PCB 89 is connected to user interfaces which are in the form of information button 64 and “OK” button 63 and an LCD display 41. A switch/mode button 84 is an input to the processor 89. Outputs from the processor are in the form of USB port 87. Outputs from the battery 14, also connected to the processor 89 are an inverter 83 and 240V power outlet 81, an Anderson outlet 47 through an isolation switch 96, and further 12V cigarette lighter outlets 45.

Relays are provided (not shown) to relay command instructions from the remote electronic device 30 to the outputs 81, 47 and 45.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A system for monitoring a battery condition, the system including:
one or more sensors configured to sense one or more battery performance parameters;
a computer processor configured to monitor battery condition and associated with the one or more sensors;
a transmitter for communicating wirelessly with a remote electronic device having a display for displaying the battery performance parameters on the display.

2. (canceled)

3. The system in accordance with claim 1 wherein a computer processing system is configured to receive battery performance parameter data from the sensors before wireless transmission.

4. The system in accordance with claim 1 including an array of individual and wireless-enabled sensors adjacent the battery for receiving data therefrom, each one transmitting their data directly to a remote device for further processing and display.

5-6. (canceled)

7. The system of claim 1 including a housing for housing the system as a standalone system, without housing the battery, for inhibiting damage to the battery testing and control system from environmental factors such as heat, water spray, bumps and the like.

8. The system of claim 1 including a transmitter configured to transmit the battery parameters and battery condition rating data and other associated testing data to a secondary display, being remote from the housing.

9. The system of claim 1 wherein the display is a smartphone which is configured to wirelessly receive the battery rating data and other battery parameter data from the computer processor associated with the battery.

10. The system of claim 1 wherein the sensors include voltage sensors.

11. The system of claim 1 including a housing or box to house the battery.

12-18. (canceled)

19. The system of claim 1 wherein the sensors are wireless units which send their data directly to the remote electronic device for further processing.

20. The system of claim 1 including a clock so that a timer is provided to time selected operations so that the computer processor can selectively time the switching on and switching off of selected electrical inputs and/or outputs.

21. A computer-implemented method for monitoring a battery condition from a position remote from the monitored battery, the method including the steps of:
sensing, with one or more sensors, data relating to one or more battery performance parameters;
wirelessly transmitting the battery performance parameter data to a remote electronic device having a display;
displaying the battery parameter data on the display.

22. The method of claim 21 including the step of requesting a battery type on the remote electronic device so that a more accurate calculation of battery charge remaining may be made.

23. The method of claim 21 including the step of selecting a charging profile depending on the input into the processing system of data relating to a type of battery to be charged.

24. The method of claim 21 including the step of amending a calculation of battery capacity and battery charge time remaining and battery discharge time remaining depending on the input into the processing system of data relating to a type and/or capacity of battery to be charged or controlled.

25. The method of claim 21 including the step of requesting input from a user of a battery capacity on the remote display to facilitate calculation of a battery capacity remaining.

26. The method of claim 21 including the step of displaying a request for parameter data relating to a type of charging power source for facilitating selection of a charge profile.

27. The method of claim 21 including the step of selecting a charging profile depending the input into the processing system of data relating to a type of charging power source.

28. The method of claim 21 including the step of transmitting charge initiating or discharge initiating commands to selected ports on the battery.

29. A computer-readable storage medium containing instructions to implement a method of remote monitoring a battery on a computer processing device, the method including the steps of:
sensing, with one or more sensors associated therewith, data relating to one or more battery performance parameters;
wirelessly transmitting battery performance data to a remote electronic device having a display;
displaying the battery parameter data on the display.

30. The medium in accordance with claim 29 including the step of receiving into a computer processing system, battery performance parameter data from the sensors.
